(19) United States
(12) Patent Application Publication
(10) Pub. No.: US 2024/0377641 A1
(43) Pub. Date: Nov. 14, 2024

(54) DISPLAY DEVICE

(71) Applicant: NTT DOCOMO, INC., Tokyo (JP)

(72) Inventors: Mikiko NAKANISHI, Chiyoda-ku (JP); Mikio IWAMURA, Chiyoda-ku (JP); Yasuo MORINAGA, Chiyoda-ku (JP)

(73) Assignee: NTT DOCOMO, INC., Tokyo (JP)

(21) Appl. No.: 18/696,495

(22) PCT Filed: Sep. 15, 2022
(86) PCT No.: PCT/JP2022/034648

§ 371 Date: Mar. 28, 2024

(30) Foreign Application Priority Data
Oct. 6, 2021 (JP) 2021-164729

(51) Int. Cl. G02B 27/01

(52) U.S. Cl. CPC G02B 27/0172; G02B 2027/0123; G02B 2027/0174; G02B 2027/0178

(57) ABSTRACT

A display device includes a transparent plate, an image light emission unit configured to emit image light toward one principal surface of the transparent plate, a transmission hologram configured to duplicate the image light emitted from the image light emission unit to transmit the image light as reproduction light, a reflection hologram provided on the other principal surface side of the transparent plate, and configured to reflect, on the one principal surface, the reproduction light transmitted by the transmission hologram and passing through the transparent plate toward an eye of the user, and an absorption layer provided on the other principal surface side of the reflection hologram, the absorption layer being formed by combining an absorption member configured to absorb a part of the reproduction light not reflected on the one principal surface of the reflection hologram and a transparent member.

### TECHNICAL FIELD

The present invention relates to a display device worn on an eye portion of a user.

### BACKGROUND ART

As a display method in an eyeglass-type display device of the related art, for example, a retinal projection method for projecting image light toward eyes of a user has been known. However, the retinal projection method has a problem that Eyebox and a viewing angle are narrow. The Eyebox is a range in which an image (virtual image) can be visually recognized even though the eyes are moved in a case where the user wears the eyeglass-type display device. Therefore, a technique for reflecting light duplicated by a transmission hologram by a reflection hologram to be focused on the Eyebox has been proposed as an example of a technique for performing Eyebox enlargement and viewing angle enlargement (see, for example, Patent Literature 1).

### CITATION LIST

### Patent Literature

Patent Literature 1: U.S. Patent Application Publication No. 2020/0174255

### SUMMARY OF INVENTION

### Technical Problem

In the method as in Patent Literature 1, the light duplicated by the transmission hologram is reflected to be focused on the Eyebox on a surface of the reflection hologram on the transmission hologram side, and thus, the user recognizes the image. On the other hand, light that is not diffracted (reflected) on the surface of the reflection hologram on the transmission hologram side due to reasons such as low diffraction efficiency of the reflection hologram enters the reflection hologram. The light entered the reflection hologram is reflected by a surface of the reflection hologram opposite to the transmission hologram due to a difference in refractive index between the reflection hologram and air. The light reflected by the surface of the reflection hologram opposite to the transmission hologram propagates through a glass plate between the reflection hologram and the transmission hologram, and is diffracted (reflected) by the reflection hologram again, for example. Thus, there is a concern that the light is incident on the eye of the user from a direction different from that of the light initially diffracted (reflected) by the surface of the reflection hologram on the transmission hologram side. As described above, when a plurality of light rays due to different reflections are reflected to the eyes of the user from different directions, there is a problem that images are viewed from the user in an overlapping manner, that is, a ghost of the image occurs.

An embodiment of the present invention has been made in view of the above circumstances, and an object thereof is to provide a display device capable of appropriately preventing images from being viewed in an overlapping manner due to incidence of a plurality of light rays due to different reflections on an eye of a user from different directions.

### Solution to Problem

In order to achieve the above object, a display device according to an embodiment of the present invention is a display device worn on an eye portion of a user, and includes a transparent plate disposed such that one principal surface faces an eye of the user when the display device is worn by the user, an image light emission unit configured to emit image light related to an image to be displayed toward the one principal surface of the transparent plate, a transmission hologram provided between the one principal surface of the transparent plate and the image light emission unit, and configured to duplicate the image light emitted from the image light emission unit to transmit the image light as reproduction light, a reflection hologram provided such that one principal surface faces the other principal surface of the transparent plate, and configured to reflect, on the one principal surface, the reproduction light transmitted by the transmission hologram and passing through the transparent plate toward the eye of the user, and an absorption layer provided on the other principal surface side of the reflection hologram, the absorption layer being formed by combining an absorption member configured to absorb a part of the reproduction light reflected on the one principal surface of the reflection hologram and a transparent member.

In the display device according to the embodiment of the present invention, a part of the reproduction light that is not reflected on one principal surface of the reflection hologram is absorbed by the absorption layer. Thus, it is possible to prevent a part of the reproduction light from entering the eye of the user. In addition, since the absorption layer is a combination of the absorption member and the transparent member, it is possible to secure a field view of the user. Accordingly, according to the display device according to the embodiment of the present invention, it is possible to prevent images from being viewed in an overlapping manner due to incidence of a plurality of light rays due to different reflections on the eye of the user from different directions.

### Advantageous Effects of Invention

According to an embodiment of the present invention, it is possible to appropriately prevent the images from being viewed in the overlapping manner due to the incidence of the plurality of light rays due to the different reflections on the eye of the user from the different directions.

### BRIEF DESCRIPTION OF DRAWINGS

FIG. 1 is a diagram schematically illustrating an entire display device according to an embodiment of the present invention.

FIG. 2 is a diagram illustrating a reflection mechanism from a side surface and illustrating light incident on the reflection mechanism.

FIG. 3 is a perspective view of a louver.

FIG. 4 is a diagram illustrating a direction of reproduction light transmitted from a transmission hologram.

### DESCRIPTION OF EMBODIMENTS

Hereinafter, an embodiment of a display device according to the present invention will be described in detail with reference to the drawings. Note that, in the description of the drawings, the same elements are denoted by the same reference signs, and redundant description will be omitted. In addition, dimensional ratios in the drawings do not necessarily coincide with dimensional ratios in the description.

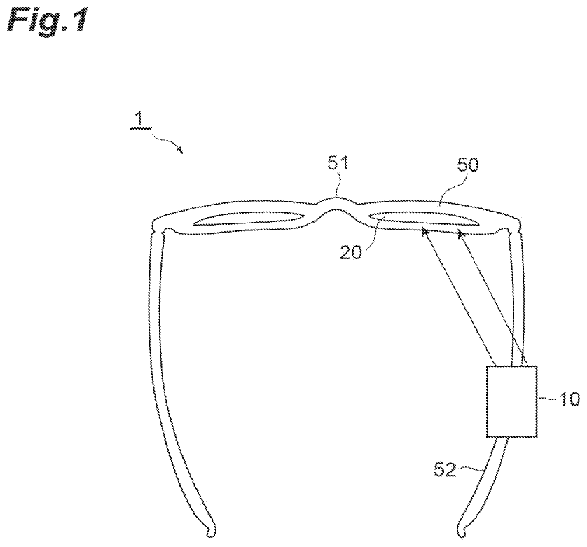

FIG. 1 schematically illustrates a display device 1 according to the present embodiment. The display device 1 is a display device worn on an eye portion of a user, and is, for example, an eyeglass-type display device illustrated in FIG. 1. The display device 1 reflects image light related to an image (visuals) to be displayed by portions corresponding to lenses of eyeglasses and projects the image light toward eyes (pupils) of a user wearing the display device 1 (hereinafter, also simply referred to as a user). When the image light is incident on the pupils of the user, the user recognizes the image. Note that, as will be described later, the image light incident on the eyes of the user is also referred to as reproduction light.

As illustrated in FIG. 1, the display device 1 includes image light emission devices 10 and reflection mechanisms 20. The reflection mechanisms 20 are mechanisms that reflect image light and projects the image light onto the eyes of the user. The reflection mechanisms 20 generally have plate shapes similarly to the lens of the eyeglasses, and are provided in the portions corresponding to the lenses. Two reflection mechanisms 20 corresponding to both the eyes of the user may be provided in the display device 1.

The display device 1 includes a frame 50 that holds the reflection mechanisms 20 in front of the eyes of the user, as a mechanism to be worn on the eye portion of the user, similarly to normal glasses. The frame 50 includes configurations such as a bridge 51 and a pair of temples 52. The bridge 51 is a member connecting two reflection mechanisms 20. Each of the temples 52 is a member that rests on a temporal region of a head of the user and enables the display device 1 to be worn by the user. Note that, a mechanism for causing the display device 1 to be worn on the eye portion of the user is not limited to the above-described mechanism, and may have any configuration.

When the display device 1 is worn by the user, the reflection mechanism 20 positioned in front of the eyes of the user transmits light in a direction from an outside toward the user. Accordingly, the user can visually recognize an external space together with the image displayed on the display device 1. That is, the display device 1 is a see-through glass (smart glass).

The image light emission devices 10 are devices that are image light emission units that emit image light related to an image to be displayed. The image light emission devices 10 are disposed to emit the image light toward a surface of the plate-shaped reflection mechanism 20, specifically, one principal surface of a transparent plate 21 of the reflection mechanism 20 to be described later. For example, as illustrated in FIG. 1, the image light emission device 10 are fixed to the temples 52 to emit the image light obliquely to the surface of the plate-shaped reflection mechanism 20. Two image light emission devices 10, respectively, corresponding to two reflection mechanisms 20 may be provided in the display device 1. In this case, for example, two image light emission devices 10 are provided one by one in the right and left temples 52.

The image light emission device 10 acquires information related to the image to be displayed, and emit image light corresponding to the acquired information. The image light emission device 10 has a communication function, and may acquire the information related to the image to be displayed from another device (not illustrated) connected in a wired or wireless manner. Alternatively, the image light emission device 10 may acquire information related to the image to be displayed stored in advance by itself.

The image light emission device 10 includes a light source that generates image light, an optical system that emits image light, and the like. The image light may be light from a light emitting diode (LED) or laser light. An image light emission device used for a micro electro-mechanical systems (MEMS) scan display of the related art can be used as the image light emission device 10. Alternatively, an image light emission device used for a planar display of the related art such as a liquid crystal on silicon (LCOS) or a digital mirror device (DMD) may be used as the image light emission device 10.

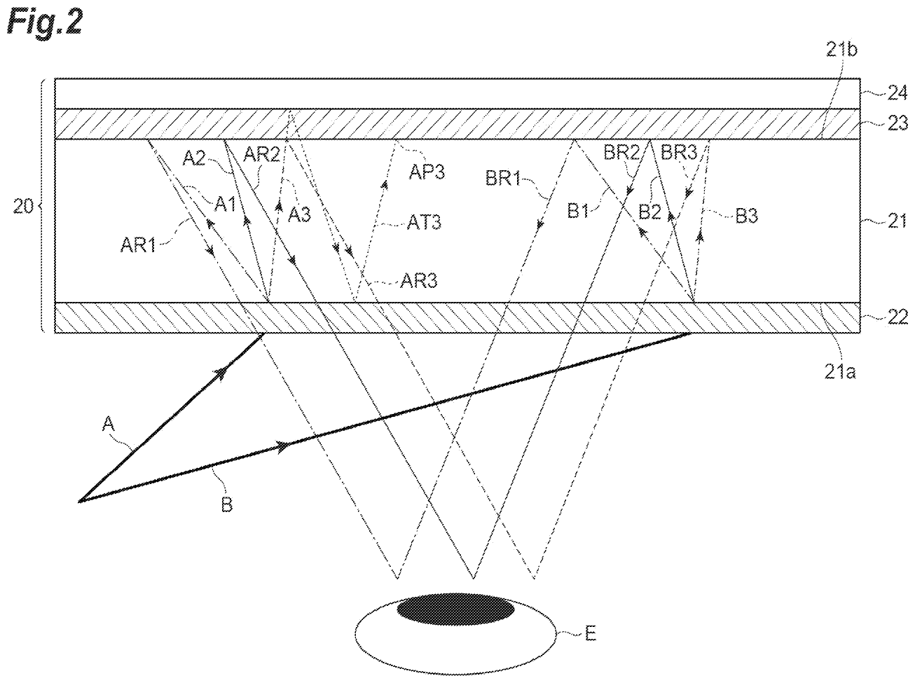

The reflection mechanism 20 is a plate-shaped mechanism having a configuration in which a plurality of plate-shaped members are layered. The reflection mechanism 20 is provided to be fixed to the frame 50 such that one principal surface, which has a plate shape, faces the eyes of the user, similar to lenses of normal glasses. FIG. 2 illustrates a plurality of plate-shaped members 21 to 24 of the reflection mechanism 20. FIG. 2 is a side view of the layered plate-shaped member 21 to 24. A downward direction in FIG. 2 is a direction toward an eye E of the user.

As illustrated in FIG. 2, the reflection mechanism 20 includes a transparent plate 21, a transmission hologram 22, a reflection hologram 23, and a louver 24. As illustrated in FIG. 2, the members 21 to 24 are layered in close contact with each other in order of the transmission hologram 22, the transparent plate 21, the reflection hologram 23, and the louver 24 from the eye E of the user.

The transparent plate 21 is a member disposed such that one principal surface 21a faces the eye E of the user when the display device 1 is worn by the user. The transparent plate 21 is made of, for example, glass or plastic. A refractive index of the transparent plate 21 is a refractive index in a range in which light can pass without being reflected on contact surfaces with the transmission hologram 22 and the reflection hologram 23.

The transmission hologram 22 is a member that is provided between one principal surface 21a of the transparent plate 21 and the image light emission device 10, duplicates the image light emitted from the image light emission device 10, and transmits the image light as the reproduction light. The transmission hologram 22 is disposed such that one of principal surfaces is in contact with one principal surface 21a of the transparent plate 21. Note that, the reproduction light is reproduction light for the transmission hologram 22.

The image light emitted from the image light emission device 10 is incident on the transmission hologram 22 from a principal surface not in contact with the one principal surface 21a of the transparent plate 21. The transmission hologram 22 transmits the incident image light as a plurality of reproduction light rays radially from the principal surface in contact with one principal surface 21a of the transparent plate 21. The reproduction light rays transmitted through the transmission hologram 22 are light rays that are incident on the eye of the user and causes the user to recognize an image. Directions of the plurality of reproduction light rays transmitted from the transmission hologram 22 are determined in advance by the transmission hologram 22. The directions are directions in which Eyebox enlargement and viewing angle enlargement are enabled.

A transmission hologram of the related art can be used as the transmission hologram 22. The transmission hologram 22 may have a transparent cover made of, for example, glass or plastic. The transparent cover is disposed to be in contact with one side or both sides of principal surfaces of the transmission hologram 22.

The reflection hologram 23 is a member that is provided such that one principal surface faces the other principal surface 21b of the transparent plate 21, and reflects, on the one principal surface, the reproduction light rays transmitted by the transmission hologram 22 and passing through the transparent plate 21 toward the eye E of the user. The transmission hologram 22 is disposed such that one of the principal surfaces is in contact with the other principal surface 21b of the transparent plate 21.

The reproduction light rays transmitted through the transmission hologram 22 are incident on the reflection hologram 23 from a principal surface in contact with the other principal surface 21b of the transparent plate 21. The reflection hologram 23 reflects the reproduction light rays on one principal surface in contact with the transparent plate 21 such that reflected light rays travel in directions parallel to each other. A case where the reflected light rays travel in the directions parallel to each other means that image light rays of pixels at the same position in the same image are duplicated by the transmission hologram 22 and are reflected by the reflection hologram 23, and then travel in the directions parallel to each other toward the eye of the user.

A reflection hologram of the related art can be used as the reflection hologram 23. The reflection hologram 23 may have a transparent cover made of, for example, glass or plastic. The transparent cover is disposed to be in contact with one surface or both surfaces of the principal surfaces of the reflection hologram 23.

In FIG. 2, for the sake of description, image light rays A and B at an end among the image light rays emitted from the image light emission device 10, and paths of transmitted light and reflected light (reproduction light) thereof are illustrated. Actually, there is image light for each pixel in addition to the image light rays A and B. The image light emission device 10 emits the image light rays A and B toward the one principal surface 21a of the transparent plate 21. The transmission hologram 22 duplicates the image light A emitted from the image light emission device 10 and transmits the image light A as reproduction light rays A1, A2, and A3. The reflection hologram 23 reflects the reproduction light rays A1, A2, and A3 transmitted through the transmission hologram 22 toward the eye E of the user. At this time, the reflection hologram 23 reflects the reproduction lights A1, A2, and A3 such that reflected light rays AR1, AR2, and AR3, respectively, corresponding to the reproduction lights A1, A2, and A3 travel in directions parallel to each other.

Similarly, the transmission hologram 22 duplicates the image light B emitted from the image light emission device 10 and transmits the image light B as reproduction light rays B1, B2, and B3. The reflection hologram 23 reflects the reproduction light rays B1, B2, and B3 transmitted through the transmission hologram 22 toward the eye of the user. At this time, the reflection hologram 23 reflects the reproduction lights B1, B2, and B3 such that reflected light rays BR1, BR2, and BR3, respectively, corresponding to the reproduction lights B1, B2, and B3 travel in directions parallel to each other.

The reflected light rays are incident on the eye E of the user as described above, and thus, even at a different position, that is, even in a case where the user moves the position of the eye E, the user can recognize the image by the reflected light rays corresponding to the position. As described above, according to the above configuration, the Eyebox enlargement and viewing angle enlargement can be performed.

The transmission hologram 22 may adjust aberration degrees of the reproduction light rays after duplication to become the same. Specifically, the transmission hologram 22 adjusts the reproduction light rays A1 and B1 corresponding to each other, which are transmitted at different positions, to become parallel, that is, the reproduction light rays A1 and B1 to be emitted in the same direction. Similarly, the transmission hologram 22 adjusts the reproduction light rays A2 and B2 to be parallel, and adjusts the reproduction light rays A3 and B3 to be parallel. As a result, the transmission hologram 22 can adjust aberration degrees of the reproduction light rays A1, A2, and A3 duplicated from the image light A and transmitted to be the same. Similarly, the transmission hologram 22 can adjust aberration degrees of the reproduction light rays B1, B2, and B3 duplicated from the image light B and transmitted to also become the same.

Next, a part of the reproduction light rays that are not reflected (reacted) on one principal surface of the reflection hologram 23 in contact with the transparent plate 21 in a case where the louver 24 is not provided will be described. The reproduction light rays that are not reflected on the principal surface of the reflection hologram 23 are enter the reflection hologram 23. FIG. 2 illustrates, as an example of the reproduction light that enters the reflection hologram 23, reproduction light AT3 that is a part of the reproduction light A3 and enters the reflection hologram 23. The reproduction light AT3 is totally reflected at an interface between the air and the other principal surface of the reflection hologram 23 not in contact with the transparent plate 21, and returns to the transparent plate 21. The reproduction light AT3 returned to the transparent plate 21 propagates through the transparent plate 21 while being reflected. The propagating reproduction light AT3 reaches one principal surface of the reflection hologram 23 in contact with the transparent plate 21 again.

The reproduction light AT3 having reached the reflection hologram 23 is reflected by one principal surface in contact with the transparent plate 21 and travels toward the eye E of the user. In addition, on the other hand, at a position AP3 where the reproduction light AT3 is reflected by the reflection hologram 23, reproduction light related to another image light is reflected and travels toward the eye E of the user. When a plurality of reproduction light rays are reflected at the same position, the user sees images in an overlapping manner. The louver 24 is for preventing a part of the reproduction light rays, which are not reflected on one principal surface of the reflection hologram 23 in contact with the transparent plate 21 from being incident on the eye E of the user. Accordingly, it is possible to prevent the user from seeing the images in the overlapping manner, that is, to prevent a ghost from occurring.

The louver 24 is a member that is an absorption layer that is provided on the other principal surface side of the reflection hologram 23 and is formed by combining an absorption member configured to absorb a part of the reproduction light rays not reflected on one principal surface of the reflection hologram 23 and a transparent member. The louver 24 may be formed by alternately combining the absorption member and the transparent member in a stripe shape. A length of the transparent member in the louver 24 in a direction perpendicularly crossing the stripe may be a length at which diffraction of light incident on the louver from a side opposite to the other principal surface of the reflection hologram is able to be prevented. A ratio between a thickness of the louver 24 and the length of the transparent member in the direction perpendicularly crossing the stripe in the louver 24 may be a ratio at which a part of the reproduction light rays is able to be absorbed and the diffraction of the light incident on the louver 24 from the side opposite to the other principal surface of the reflection hologram 23 is able to be prevented.

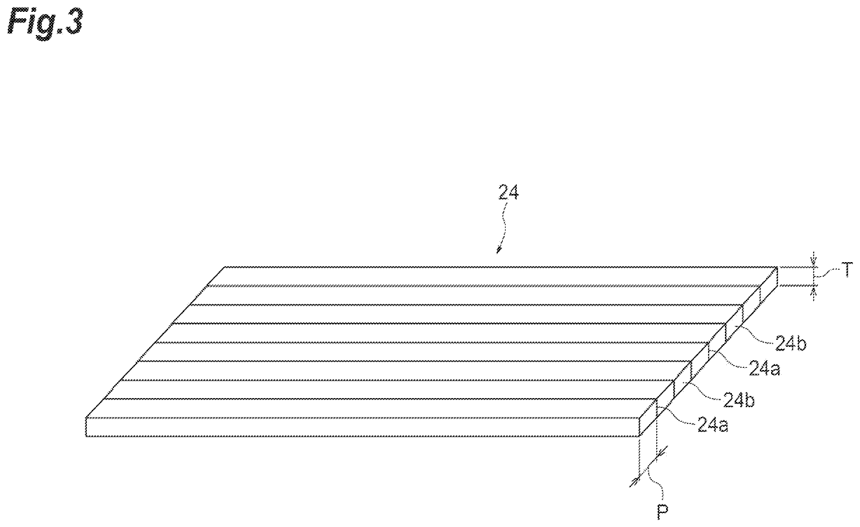

As illustrated in FIG. 2, the louver 24 is disposed such that one of the principal surfaces is in contact with the other principal surface of the reflection hologram 23 that is not in contact with the transparent plate 21. FIG. 3 illustrates the louver 24 as viewed obliquely. As illustrated in FIG. 3, the louver 24 is a member in which absorption members 24a and transparent members 24b are combined. A thickness (length) T of the louver 24 is, for example, 50 μm.

The absorption member 24a is a member that absorbs a part of the reproduction light rays (visible light rays) not reflected on one principal surface of the reflection hologram 23. The absorption member 24a is made of, for example, black silicone rubber. The transparent member 24b is made of, for example, glass or plastic. For example, as illustrated in FIG. 3, the louver 24 is formed by alternately combining a plurality of elongated absorption members 24a and a plurality of elongated transparent members 24b in a stripe shape. For example, the louver 24 can be formed by stacking and bonding the plurality of absorption members 24a and the transparent members 24b each having a plate shape and cutting the stacked members into plate shapes in a stacking direction. Refractive indexes of the absorption member 24a and the transparent member 24b are refractive indexes in a range where light can pass without being reflected on a contact surface with the reflection hologram 23. For example, the refractive index of the transparent member 24b and the refractive index of the reflection hologram 23 have values close to each other. The refractive index of the transparent member 24b may have a value larger than the refractive index of the reflection hologram 23. In addition, in a case where the refractive index of the transparent member 24b is smaller than the refractive index of the reflection hologram 23, the refractive index is set such that light is not reflected at a boundary between the transparent member 24b and the reflection hologram 23.

A part of the reproduction light rays not reflected on one principal surface of the reflection hologram 23 is incident on the louver 24 and is absorbed by the transparent member 24b. In addition, the transparent member 24b is provided in the louver 24, and thus, the reflection mechanism 20 can transmit light in a direction from the outside toward the user as described above. Note that, as long as a part of the reproduction light rays can be absorbed and the light in the direction from the outside toward the user can be transmitted, the combination of the absorption members 24a and the transparent members 24b in the louver 24 does not necessarily have the stripe shape as described above.

When a pitch P, which is the length of each transparent member 24b in the direction perpendicularly crossing the stripe, is narrow, light incident on the louver 24 from the outside (light incident on the louver 24 from the side opposite to the other principal surface of the reflection hologram 23) is diffracted. When diffraction occurs, the user sees an outside view as blurred. Therefore, the pitch P may be a length that can prevent the diffraction of the light from the outside. For example, the pitch P is 400 μm or more. This length is a length at which the user sees the light from the outside without diffraction when the louver 24 is disposed at a position 1.5 cm from the eye E of the user.

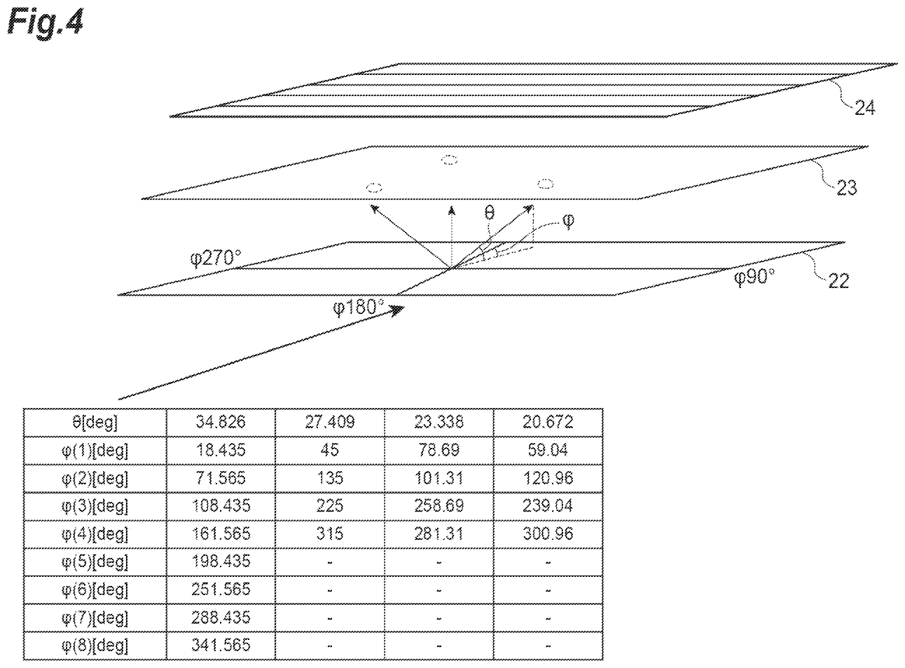

A ratio between the thickness T of the louver 24 and the pitch P may be a ratio at which a part of the reproduction light rays can be absorbed and the diffraction of the light incident on the louver 24 can be prevent from the outside. For example, in a case where the directions of the reproduction light rays transmitted from the transmission hologram 22 are as illustrated in FIG. 4 due to a property of the transmission hologram 22 and a positional relationship between the image light emission device 10 and the reflection mechanism 20, the ratio between the thickness T and the pitch P of the louver 24 may be 4:3. Note that, in FIG. 4, the transparent plate 21 is omitted.

In the example illustrated in FIG. 4, the number of directions of the reproduction light rays transmitted from the transmission hologram 22 is 20. A table of FIG. 4 shows the directions. Directions in which an elevation angle θ is 34.826° are eight directions in which azimuth angles φ are 18.435°, 71.565°, 108.435°, 161.565°, 198.435°, 251.565°, 288.435°, and 341.565°. Similarly, directions in which the elevation angle θ is 27.409° are four directions of four azimuth angles φ illustrated in FIG. 4. Directions in which the elevation angle θ is 23.338° are four directions of four azimuth angles φ illustrated in FIG. 4. Directions in which the elevation angle θ is 20.672° are four directions of four azimuth angles φ illustrated in FIG. 4. In the above description, the azimuth angle φ indicates a direction with a preset direction on the principal surface of the transmission hologram 22 as a reference, and the elevation angle θ indicates an angle from the transmission hologram 22 toward the reflection hologram 23 with the principal surface of the transmission hologram 22 as a reference, that is, an angle (within a critical angle) of the reproduction light propagating through the transparent plate 21.

Note that, the reproduction light rays may be transmitted in a direction other than the above directions as long as all of the reproduction light rays are reflected on one principal surface of the reflection hologram 23, that is, the reproduction light rays do not enter the reflection hologram 23.

The louver 24 may be provided such that the absorption members 24a and the transparent members 24b form horizontal stripes as viewed from the user when the display device 1 is worn by the user. That is, the directions of elongated absorption members 24a and transparent members 24b may be substantially the same as the direction connecting both the eyes of the user. Since the absorption members 24a are colored members, there is a concern that the absorption members may become an obstacle when the user sees the outside view. The absorption members 24a and the transparent members 24b are disposed as described above, and thus, it is possible to set the absorption members 24a to be less likely to interfere with a visual field of the user in a left-right direction (horizontal direction). As a result, the visual field of the user in the left-right direction can be widened. The above description is the configuration of the display device 1.

In the present embodiment, it is possible to realize the Eyebox enlargement and viewing angle enlargement by reflecting the duplicated reproduction light rays toward the eyes of the user in a display method for projecting image light toward the eyes of the user.

Moreover, in the present embodiment, a part of the reproduction light rays not reflected on one principal surface of the reflection hologram 23 is absorbed by the louver 24. Thus, it is possible to prevent a part of the reproduction light from entering the eye of the user. In addition, since the louver 24 is the combination of the absorption members 24a and the transparent members 24b, the user can see the outside view as described above. That is, a field of view of the user can be secured. Accordingly, according to the present embodiment, it is possible to prevent images from being seen in an overlapping manner due to incidence of a plurality of light rays due to different reflections on the eyes of the user from different directions.

Note that, in order to prevent the reflection of the reproduction light rays, it is also conceivable to provide the absorption member on the entire outer surface of the reflection hologram 23. In this case, the color of the absorption member is given to the outside view seen by the user, or the user cannot see an outside view in the first place. That is, the field of view of the user cannot be accurately secured. In the present embodiment, it is possible to secure the field of view without causing the above-described problem.

In addition, as in the above-described embodiment, the louver 24 may be the combination in which the absorption members 24a and the transparent members 24b are alternately combined in the stripe shape. According to this configuration, the louver 24 can be easily and reliably formed, and the display device 1 according to the present embodiment can be easily and reliably realized.

In addition, in this case, the pitch P of the transparent members 24b in the louver 24 may be a length that can prevent the diffraction of the light incident on the louver 24 from the outside. According to this configuration, it is possible to prevent the outside view from blurring as described above.

In addition, the ratio between the thickness T of the louver 24 and the pitch P of the transparent members 24b in the louver 24 may be a ratio at which a part of the reproduction light rays can be absorbed and the diffraction of the light incident on the louver 24 from the side opposite to the other principal surface of the reflection hologram 23 can be prevent. According to this configuration, it is possible to appropriately prevent images from being seen in an overlapping manner and to prevent the outside view from blurring.

In addition, the louver 24 may be provided such that the absorption members 24a and the transparent members 24b form horizontal stripes as viewed from the user when the display device 1 is worn by the user. According to this configuration, the visual field of the user in the left-right direction can be widened.

However, the louver 24 does not necessarily need to have the above-described configurations, and simply needs to be a combination of an absorption member and a transparent member.

Each aspect/embodiment described in the present disclosure may be used alone, or may be used in combination, or may be switched with execution.

Although the present disclosure has been described in detail above, it is apparent to those skilled in the art that the present disclosure is not limited to the embodiments described in the present disclosure. The present disclosure can be implemented as modifications and variations without departing from the spirit and scope of the present disclosure defined by the claims. Therefore, the description of the present disclosure is for the purpose of illustration and does not have any restrictive meaning to the present disclosure.

The terms “connected”, “coupled”, or any variation thereof, mean any direct or indirect connection or coupling between two or more elements, and can include the presence of one or more intermediate elements between two elements that are “connected” or “coupled” to each other. The coupling or connection between the elements may be physical, logical, or a combination thereof. For example, “connection” may be read as “access”. As used in this disclosure, two elements can be considered to be “connected” or “coupled” to one another using at least one of one or more wires, cables, printed electrical connections, and as some non-limiting and non-exhaustive examples, using electromagnetic energy having wavelengths in the radio frequency region, the microwave region, and the light (both visible and invisible) region, and the like.

As used in this disclosure, the phrase “based on” does not mean “based only on” unless explicitly stated otherwise. In other words, the description “based on” means both “based only on” and “based at least on”.

Any reference to elements using designations such as “first”, “second”, and the like as used in the present disclosure does not generally limit the amount or order of those elements. These designations may be used in the present disclosure as a convenient way to distinguish between two or more elements. Thus, reference to first and second elements does not imply that only two elements may be employed or that the first element must in any way precede the second element.

Where the present disclosure uses the terms “include”, “including”, and variations thereof, these terms are intended to be inclusive in a manner similar to the term “comprising”. Further, the term “or” used in the present disclosure is intended not to be an exclusive OR.

In the present disclosure, for example, in a case where articles such as a, an, and the in English are added by translation, the present disclosure may include a case where a noun following these articles is a plural form.

In the present disclosure, the term “A and B are different” may mean “A and B are different from each other”. Note that, the term may mean that “A and B are different from C”. Terms such as “separated”, “coupled” and the like may also be interpreted in the same manner as “different”.

### REFERENCE SIGNS LIST

1 display device

10 image light emission device

20 reflection mechanism

21 transparent plate

22 transmission hologram

23 reflection hologram

24 louver

24a absorption member

24b transparent member

50 frame

51 bridge

52 temple.

1. A display device worn on an eye portion of a user, comprising:
a transparent plate disposed such that one principal surface faces an eye of the user when the display device is worn by the user;
an image light emission device configured to emit image light related to an image to be displayed toward the one principal surface of the transparent plate;
a transmission hologram provided between the one principal surface of the transparent plate and the image light emission device, and configured to duplicate the image light emitted from the image light emission device to transmit the image light as reproduction light;
a reflection hologram provided such that one principal surface faces the other principal surface of the transparent plate, and configured to reflect, on the one principal surface, the reproduction light transmitted by the transmission hologram and passing through the transparent plate toward the eye of the user; and
an absorption layer provided on the other principal surface side of the reflection hologram, the absorption layer being formed by combining an absorption member configured to absorb a part of the reproduction light not reflected on the one principal surface of the reflection hologram and a transparent member.

2. The display device according to claim 1, wherein
the absorption layer is formed such that the absorption member and the transparent member are alternately combined in a stripe shape.

3. The display device according to claim 2, wherein
a length of the transparent member in a direction perpendicularly crossing a stripe in the absorption layer is a length at which diffraction of light incident on the absorption layer from a side opposite to the other principal surface of the reflection hologram is able to be prevented.

4. The display device according to claim 2, wherein
a ratio between a thickness of the absorption layer and a length of the transparent member in a direction perpendicularly crossing a stripe is a ratio at which the part of the reproduction light is able to be absorbed and diffraction of light incident on the absorption layer from a side opposite to the other principal surface of the reflection hologram is able to be prevented.

5. The display device according to claim 2, wherein
the absorption layer is provided such that the absorption member and the transparent member form horizontal stripes as viewed from the user when the display device is worn by the user.

6. The display device according to claim 3, wherein
a ratio between a thickness of the absorption layer and a length of the transparent member in a direction perpendicularly crossing a stripe is a ratio at which the part of the reproduction light is able to be absorbed and diffraction of light incident on the absorption layer from a side opposite to the other principal surface of the reflection hologram is able to be prevented.
